(19) United States
(12) Patent Application Publication
(10) Pub. No.: US 2016/0349532 A1
(43) Pub. Date: Dec. 1, 2016

(54) LENS DRIVING DEVICE WITH SHAKING CORRECTION FUNCTION

(71) Applicants: Huizhou Dayawan Ever Bright Electronic Industry Co., Ltd., Huizhou (CN); JSS Optical Technology Co., Ltd., HONG KONG (HK); Huizhou Daya Bay Jss Optical Technology.Co., Ltd., Huizhou (CN)

(72) Inventor: Kokichi Terajima, Tokyo (JP)

(21) Appl. No.: 15/152,555

(22) Filed: May 12, 2016

(30) Foreign Application Priority Data
May 28, 2015 (JP) 2015-108941

(51) Int. Cl. G02B 27/64; G03B 13/36; G02B 7/09

(52) U.S. Cl. CPC G02B 27/646; G02B 7/09; G03B 13/36

(57) ABSTRACT

The present invention provides a lens driving device with a shaking correction function and having good driving efficiency. The lens driving device includes an auto focus unit for enabling a lens to move along an optical axis and a shaking correction unit for enabling the auto focus unit to swing in directions perpendicular to the optical axis. The auto focus unit includes a focus coil and several magnets. The shaking correction unit includes several correction coils. The magnets are magnetized along directions not perpendicular to the optical axis. Thus positions of the inner side edges or the outer side edges of the correction coils can be adjusted along the radial direction of a base substrate to form a small size lens driving device or use large size lens.

### BACKGROUND OF THE INVENTION

### 1. Field of the Invention

The present invention relates to a lens driving device with a shaking correction function used for a camera.

### 2. Description of Related Art

A lens driving device with a shaking correction function includes an auto focus unit for enabling a lens to move in the direction of an optical axis and enabling an image of an object to be shot to be focused on an image sensor, and a shaking correction unit for enabling the auto focus unit to swing in directions forming a right angle with the optical axis of the lens and inhibiting image blurring caused by shaking.

For example, JP patent application publication No. 2013-24938, publication date Feb. 4, 2013 (also published as JP5821356B2, US2013016427A1, U.S. Pat. No. 9,036,260B2, US2015226978A1) provides a lens driving device with a shaking correction unit. The shaking correction unit in the following manner for inhibiting image blurring is arranged in the lens driving device, namely the auto focus unit is supported by suspension wires extending along the direction of the optical axis in a suspended manner to be capable of swinging, and a coil and magnets for swing the lens are utilized so as to enable the lens to swing in directions forming the right angle with the optical axis.

As shown in FIG. 5A, in the lens driving device 30 with a shaking correction unit, a lens 41 is maintained in a cannular part formed in the center, the lens 41 moves in the direction of the optical axis O (Z axis direction) for focusing, and the lens 41 swings in directions forming the right angle with the Z axis (X axis direction and Y axis direction) so as to inhibit image blurring caused by shaking.

As shown in FIG. 5B, the lens driving device 30 with the shaking correction function includes the focus unit 31 for enabling the lens 41 to move along the Z axis direction and the shaking correction unit 32 for enabling the lens 41 to swing in directions forming the right angle with the Z axis. Hereon, the direction of the optical axis O of the lens 41 is set to be the Z axis direction (the object to be shot is at +Z side of the Z axis direction), and two directions forming right angles with the Z axis and perpendicular with each other are set to be the X axis direction and the Y axis direction respectively.

The focus unit 31 includes a lens carrier 33, a focus coil 34, magnets 35, a magnet support 36 and two plate springs 37. Moreover, the shaking correction unit 32 includes a base substrate 38, coils 39 for swinging the lens 41 and formed on the base substrate, the magnets 35 shared with the focus unit 31, and four suspension wires 40.

The lens carrier 33 is a cylindrical component with an opening defined in the Z axis direction, and the lens 41 is maintained in a cannular part 33a. The focus coil 34 wound around the axis parallel to the Z axis is mounted on the periphery of the lens carrier 33.

The magnets 35 include a +X side flat magnet piece 35XP, a −X side flat magnet piece 35XM, a +Y side flat magnet piece 35YP and a −Y side flat magnet piece 35YM. The magnets 35 are all formed in the shapes of cuboids. The magnet support 36 is formed in the shape of a square frame, and is used for maintaining the +X side flat magnet piece 35XP, the −X side flat magnet piece 35XM, the +Y side flat magnet piece 35YP and the −Y side flat magnet piece 35YM.

The plate springs 37 include a plate spring 37A in the front and a plate spring 37B at the back. The inner edge of the plate spring 37A is connected with the +Z side end face of the lens carrier 33, and the inner edge of the plate spring 37B is connected with the −Z side end face of the lens carrier 33. Moreover, the outer edge of the plate spring 37A is connected with the +Z side end face of the magnet support 36, and the outer edge of the plate spring 37B is connected with the −Z side end face of the magnet support 36. As a result, the plate springs 37 are used for supporting the lens carrier 33 in a suspended mode to be capable of moving in the Z axis direction. Moreover, the plate spring 37A is divided into two parts along the X axis direction, and also serves as one part of a power supply path leading to the focus coil 34.

The +X side flat magnet piece 35XP is configured on the +X side of the focus coil 34 and is magnetized along the X axis direction, and the magnetic pole face 35m and the focus coil 34 are isolated at an interval along the X axis direction and are arranged opposite to each other. The −X side flat magnet piece 35XM is configured on the −X side of the focus coil 34 and is magnetized along the X axis direction, and the magnetic pole face 35m and the focus coil 34 are isolated at an interval along the X axis direction and are arranged opposite to each other. The +Y side flat magnet piece 35YP is configured on the +Y side of the focus coil 34 and is magnetized along the Y axis direction, and the magnetic pole face 35m and the focus coil 34 are isolated at an interval along the Y axis direction and are arranged opposite to each other. The −Y side flat magnet piece 35MM is configured on the −Y side of the focus coil 34 and is magnetized along the Y axis direction, and the magnetic pole face 35m and the focus coil 34 are isolated at an interval along the Y axis direction and are arranged opposite to each other.

In the focus unit formed as mentioned above, when the focus coil 34 is electrified, lorentz force in the Z axis direction is generated by the focus coil 34, so that the lens carrier 33 moves towards the Z axis direction until the lorentz force and the restoring force of the plate spring 37 reach a balanced position.

The base substrate 38 is a quadrangular platelike component with a circular opening part 38a. The coils 39 for swing the lens 41 include a +X side coil 39XP, a −X side coil 39XM, a +Y side coil 39YP and a −Y side coil 39YM. Each of the coils 39 is plate-shaped with an opening defined in the center, and is formed in a shape of a long circle.

Each of the coils 39 for swing the lens 41 is a component formed by winding a copper wire, is configured on the outer side of the opening part 38a of the base substrate 38, and is closer to the outerside edge of the base substrate 38 in radial direction. The coils 39 are mounted on the +Z side face (face on the +Z side) of the base substrate 38. More specifically, the +X side coil 39XP is wound around an axis parallel to the Z axis in the shape of a long circle, and is isolated from the −Z side face (side face on the −Z side) of the +X side flat magnet piece 35XP at an interval along the Z axis direction and is arranged opposite to the −Z side face of the +X side flat magnet piece 35XP. Moreover, the −X side coil 39XM is wound around an axis parallel to the Z axis in the shape of a long circle, and is isolated from the side face on the −Z side of the −X side flat magnet piece 35XM at an interval along the Z axis direction and is arranged opposite to the −Z side face of the −X side flat magnet piece 35XM. Moreover, the +Y side coil 39YP is wound around the axis parallel to the Z axis in the shape of the long circle, and is isolated from the side face on the −Z side of the +Y side flat magnet piece 35YP at an interval along the Z axis direction and is arranged opposite to the side face on the −Z side of the +Y side flat magnet piece 35YP. Moreover, the −Y side coil 39YM is wound around the axis parallel to the Z axis in the shape of the long circle, and is isolated from the side face on the −Z side of the −Y side flat magnet piece 35YM at an interval along the Z axis direction and is arranged opposite to the side face on the −Z side of the −Y side flat magnet piece 35YM.

Each suspension wire 40 is a linear component extending along the Z axis direction, and there are four suspension wires 40 arranged in the shaking correction unit 32. One end part of each suspension wire 40 passes through the plate spring 37B in a non-contact manner so as to be connected with one of the corner parts 38c of the base substrate 38, and the other end part is connected with one of the corner parts 37c of the plate spring 37A. The suspension wires 40 are used for supporting the focus unit 31 to be capable of swinging in the X axis direction and the Y axis direction.

In the shaking correction unit 32 formed as mentioned above, when the +X side coil 39XP and the −X side coil 39XM are electrified, the lorentz force in the X axis direction is generated by the +X side coil 39XP and the −X side coil 39XM respectively, and counter-acting force is generated by the +X side flat magnet piece 35XP and the −X side flat magnet piece 35XM, so that the focus unit 31 swings in the X axis direction. Similarly, when the +Y side coil 39YP and the −Y side coil 39YM are electrified, the lorentz force in the Y axis direction is generated by the +Y side coil 39XP and the −Y side coil 39YM respectively, and counter-acting force is generated by the +Y side flat magnet piece 35YP and the −Y side flat magnet piece 35YM, so that the focus unit 31 swings in the Y axis direction.

As shown in FIG. 5C, the magnetization directions M of the +X side flat magnet piece 35XP, the −X side flat magnet piece 35XM, the +Y side flat magnet piece 35YP and the −Y side flat magnet piece 35MM are magnetized in the directions forming right angles with the magnetic pole faces 35m respectively. And then, the +X side coil 39XP, the −X side coil 39XM, the +Y side coil 39YP and the −Y side coil 39YM of the coils 39 for swing the lens 41 are respectively configured on the positions that more magnetic induction lines in the Z axis direction are crossed.

Namely, the magnetization direction M of the −X side flat magnet piece 35XM and the magnetic pole face 35m form the right angle. And then, near the −Z side of the inner side corner part 35i (that is, an corner between the inner side face and the −Z side end face, close to the coils 39 and the focus coil 34) of the −X side flat magnet piece 35XM and near the −Z side of the outer side corner part 35o of the −X side flat magnet piece 35XM, the −X side coil 39XM suffers from the strongest magnetic field.

Therefore, as shown in FIG. 5C and FIG. 6A, the inner side 39i of the −X side coil 39XM is configured under the −Z side of the inner side corner part 35i, and the outer side 39o is configured under the −Z side of the outer side corner part 35o, so that the lorentz force in the X axis direction can be mostly efficiently generated. The +X side coil 39XP and the +X side flat magnet piece 35XP are also similarly configured accordingly so as to generate the lorentz force in the X axis direction mostly efficiently. The +Y side coil 39YP and the +Y side flat magnet piece 35YP, and the −Y side coil 39YM and the −Y side flat magnet piece 35MM are also similarly configured, so that the lorentz force in the Y axis direction can be mostly efficiently generated. Thus, the coils 39 for swing the lens 41 can enable the shaking correction unit 32 to swing efficiently.

However, miniaturization is required at present for the lens driving device 30 with the shaking correction unit, so that the dimensions in the Z axis direction are required to be reduced (lowered). Therefore, the coils 39 for swing the lens 41 is commonly selected from a copper component as shown in FIG. 6A composed of a flexible printed substrate as shown in FIG. 6B and the like. The coils 39 for swing the lens 41 composed of the flexible printed substrate and the like is formed on a printed substrate 42 extending along the direction orthogonal with the Z axis in a face shape through printing, and is being thinned. The coils 39 for swing the lens 41 formed through printing is formed into a flatly helical coil pattern on the printed substrate 42 through the methods such as copper etching and copper electroplating.

Under the condition that the coils 39 wound with the copper component is used as shown in FIG. 6A, the dimensions of the end 38e of the base substrate 38 are shortened at the end position of the outer side edge 39o of the coils 39 for swing the lens 41. However, under the condition that the coils 39 formed through printing as shown in FIG. 6B is used, the end 42e of the printed substrate 42 is located at the state that the end 42e of the printed substrate 42 leaves away from a certain distance from the end of the outer side edge 39o of the coils 39 for swing the lens 41. The reason lies in that a pattern gap 42k as printing allowance for printing an anti-corrosion agent material needs to be arranged in the working procedure before online patterns are formed. Thus, the end 38e of the base substrate 38 also becomes larger.

Namely, the position of the coils 39 as mentioned above for obtaining good driving efficiency of the magnets 35 is restricted, and thus compared with the lens driving device 30 with the shaking correction function using the coils 39 wound with the copper component, the dimensions of the lens driving device 30 in the Z axis direction using the coils 39 formed through printing can be shortened, but on the other hand, the lens driving device has the disadvantage that the dimensions in the X axis direction and the Y axis direction become larger.

Moreover, when the shaking correction function is started to enable the focus unit 31 to swing in the X axis direction and the Y axis direction, light rays penetrating through the lens 41 can be sheltered by the opening part 38a of the base substrate 38, aperture shadow possibly occurs, and thus the lens with large aperture is optimized. However, due to the fact that the position of the coils 39 for swing the lens 41 as mentioned above for obtaining good driving efficiency of the magnets 35 is restricted, the aperture is difficult to become large sufficiently so as to exceed the inner side edge 39i of the coils 39 for swing the lens 41.

### BRIEF SUMMARY OF THE INVENTION

The present invention aims to provide a lens driving device with a shaking correction function, and good driving efficiency can also be obtained under the condition that an inner side edge or an outer side edge of a correction coil the lens changes along a radial direction of a base substrate.

The lens driving device with the shaking correction function includes an auto focus unit for enabling a lens to move in the direction of an optical axis when an object to be shot is set to be in the front of the direction of the optical axis of the lens and a shaking correction unit for enabling the auto focus unit to swing in directions forming a right angle with the optical axis. The auto focus unit includes a focus coil which is mounted on the peripheral side of the lens and wound around the optical axis and several magnets which are configured on the peripheral side of the focus coil. A magnetic pole face of each magnet is isolated from the focus coil at an interval along the radial direction and is arranged opposite to the focus coil. The shaking correction unit includes several correction coils each of which is wound around the optical axis and is isolated from a corresponding one of the magnets at an interval along the direction of the optical axis and is arranged opposite to the correction coil. The magnets are magnetized along directions those are not perpendicular to the optical axis or along a first direction which is rotated around a second direction from the a normal of the magnetic pole face of the magnet for an angle, the second direction is perpendicular to the optical axis and the normal of the magnetic pole face of the magnet.

Thus, under the condition that the good driving efficiency is maintained, both or one of the inner side edge and the outer side edge of the correction coil can be staggered towards or away in the radial direction of the base substrate. As a result, the configuration design DOF (degree of freedom) of the correction coil can be improved.

Preferably, the magnetization direction of the magnet is inclined towards the front side of the direction of the optical axis relative to the normal of the magnetic pole face when the cross section of the magnet is observed from the plane including the optical axis and the normal of the magnetic pole face.

Thus, under the condition that the good driving efficiency is not damaged, both or one of the inner side edge and the outer side edge of the correction coil can be staggered towards the inner side in the radial direction of the base substrate. As a result, the small lens driving device with the shaking correction function with shortened radial dimensions can be provided.

Preferably, the magnetization direction of the magnet is inclined towards the back side of the direction of the optical axis relative to the normal of the magnetic pole face when the cross section of the magnet is observed from the plane including the optical axis and the normal of the magnetic pole face.

Thus, under the condition that the good driving efficiency is not damaged, both or one of the inner side edge and the outer side edge of the correction coil can be staggered towards the outer side in the radial direction of the base substrate. As a result, the lens driving device with the shaking correction function for enabling the diameter of the opening part of the base substrate to be enlarged while the opening part of the base substrate is difficult to generate the aperture shadow can be provided.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1A is a perspective view illustrating a lens and a lens driving device with a shaking correction function in accordance with a first embodiment of the present invention.

FIG. 1B is an exploded view of the lens driving device with a shaking correction function in accordance with the first embodiment of the present invention.

FIG. 2A is a cross-sectional view of the main parts of the lens driving device in the first embodiment.

FIG. 2B is an explanatory view illustrating a part of the main parts of the lens driving device in accordance with the first embodiment of the present invention, a magnetization direction of the magnet is shown.

FIG. 2C is a diagram illustrating the change of the drive force (magnetic induction force) according to the change of an inclined magnetization angle in accordance with the first embodiment of the present invention.

FIG. 2D is a diagram illustrating the magnetic lines, passing through a focus coil and a correction coil for swinging the lens, of a magnet, in accordance with the first embodiment of the present invention.

FIG. 3 is a perspective view illustrating the main part of the lens driving device with the shaking correction function in the first embodiment.

FIG. 4A is an explanatory view illustrating a part of the main parts of the lens driving device in accordance with a second embodiment of the present invention, a magnetization direction of the magnet is shown.

FIG. 4B is a perspective view illustrating the main part of the lens driving device with the shaking correction function in the second embodiment.

FIG. 5A is an perspective view illustrating a lens and an existing lens driving device with a shaking correction function.

FIG. 5B is an exploded view of the existing lens driving device.

FIG. 5C is a diagram illustrating the magnetic lines, passing through a focus coil and a correction coil for swinging the lens, of a magnet of the existing lens driving device.

FIG. 6A and FIG. 6B are perspective views illustrating the configuration of main parts of two existing lens driving devices with shaking correction functions.

### DETAILED DESCRIPTION OF THE INVENTION

The invention will now be described in detail through several embodiments with reference to the accompanying drawings.

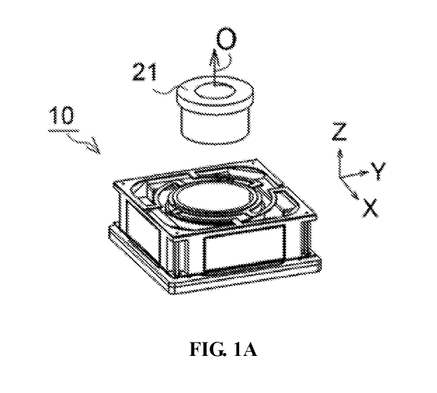

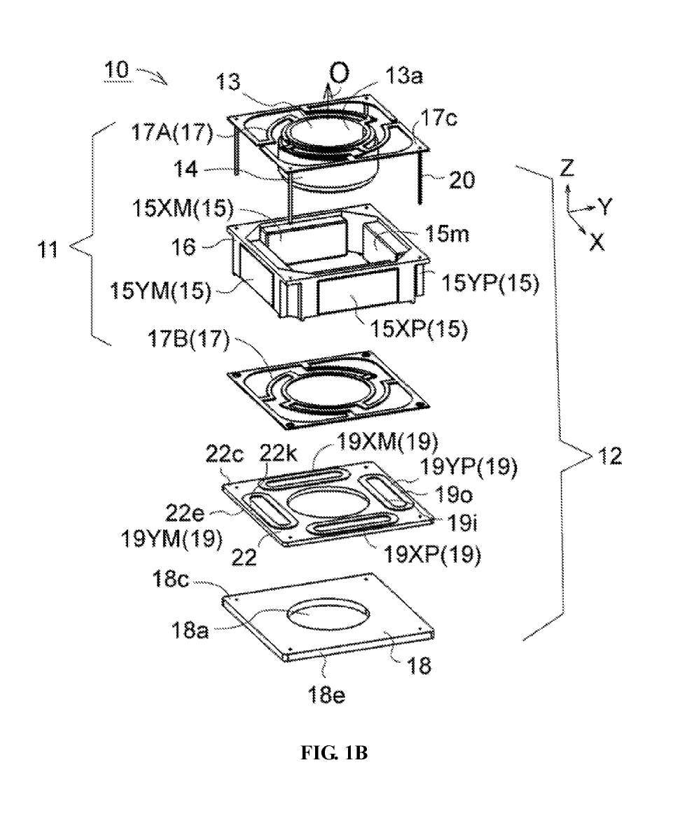

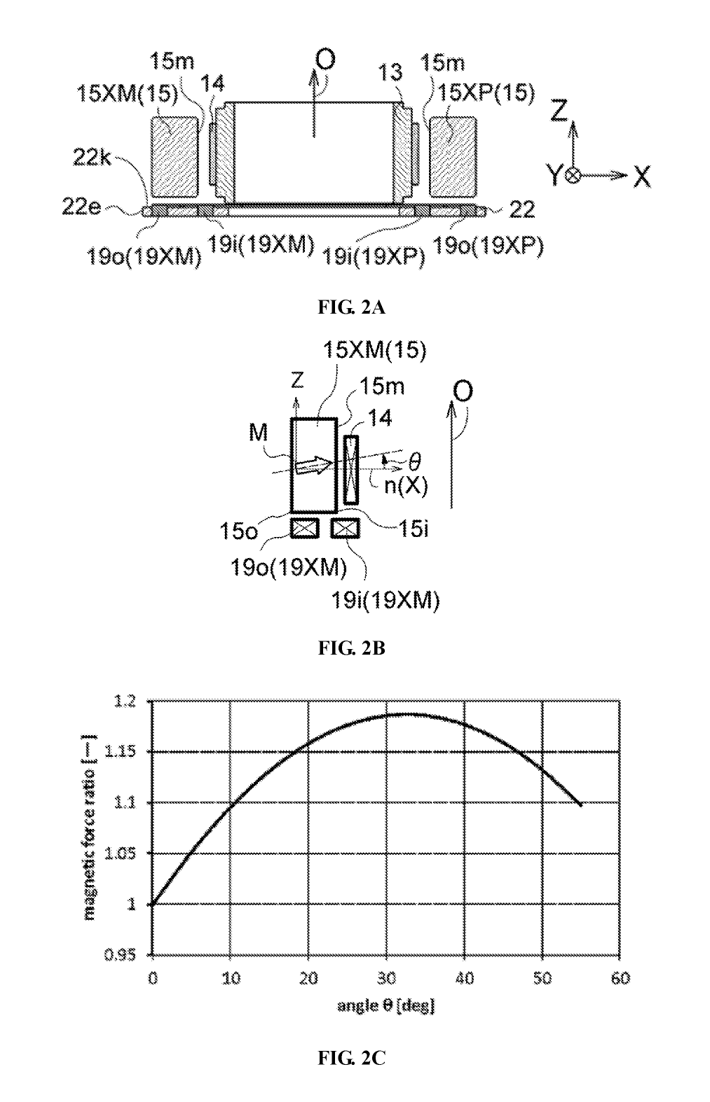

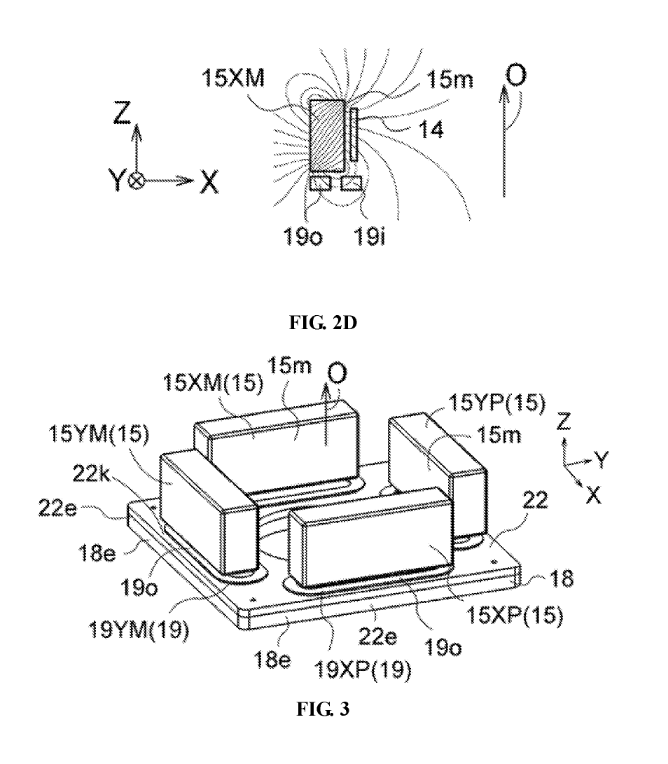

FIG. 1A is a perspective view illustrating a lens 21 and a lens driving device 10 with a shaking correction function in accordance with a first embodiment, and FIG. 1B is an exploded view of the lens driving device 10. Moreover, FIG. 2A is a cross-sectional view of the main parts of the lens driving device 10. FIG. 2B is an explanatory view for illustrating the magnetization direction M on a magnet 15 and its relationship with a focus coil 14 and a driving coil 19XM. FIG. 2C is a diagram illustrating the drive force (lorentz force) generated for the correction coil based on the inclination angle of an inclined magnetization. FIG. 2D is a diagram illustrating the magnetic line, passing through the focus coil 14 and the driving coil 19XM, of the magnet 15.

For the convenience of describing the configuration of the lens driving device 10, in the following description, the direction of the optical axis O of the lens 21 is set to be Z axis direction (an object to be shot is at the +Z side of the Z axis direction), and the two directions forming right angles with Z axis and perpendicular with each other are set to be X axis direction and Y axis direction.

As shown in FIG. 1A, a cannular part 13a is formed in the center of the lens driving device 10, and the lens 21 is maintained in the cannular part. The lens driving device 10 enables the maintained lens 21 to be moved and focused in the direction of an optical axis O (Z axis direction), and the lens 21 can swing in directions forming the right angle with the Z axis (X axis direction and Y axis direction) so as to inhibit image blurring caused by shaking.

As shown in FIG. 1B, the lens driving device 10 includes a focus unit 11 for enabling the lens 21 to move along the Z axis direction and a shaking correction unit 12 for enabling the lens 21 to swing in directions forming the right angle with the Z axis.

The focus unit 11 includes a lens carrier 13, a focus coil 14, magnets 15, a magnet support 16 and plate springs 17. Moreover, the shaking correction unit 12 includes a base substrate 18, a printed substrate 22, correction coils 19 formed on the printed substrate 22 and used for swinging the lens 41, the magnets 15 which are also used in the focus unit 11 (that is, shared with the focus unit 11), and suspension wires 20.

The lens carrier 13 is a cylindrical component with an opening defined in the Z axis direction, and the lens 21 is maintained in the cannular part 13a defining the opening. The focus coil 14 wound along the periphery of the Z axis is mounted on the periphery of the lens carrier 13.

The magnets 15 include a +X side flat magnet piece 15XP, a −X side flat magnet piece 15XM, a +Y side flat magnet piece 15YP and a −Y side flat magnet piece 15YM. These flat magnet pieces 15XP, 15XM, 15YP and 15YM are all formed in the shapes of cuboids. The magnet support 16 is formed in the shape of a square frame, and is provided with maintaining parts for maintaining the +X side flat magnet piece 15XP, the −X side flat magnet piece 15XM, the +Y side flat magnet piece 15YP and the −Y side flat magnet piece 15YM.

The +X side flat magnet piece 15XP is configured on the +X side of the focus coil 14. The magnetic pole face 15m of the +X side flat magnet piece 15XP and the winding side face of the focus coil 14 are isolated at an interval along the X axis direction and are arranged opposite to (face to face) each other. The −X side flat magnet piece 15XM is configured on the −X side of the focus coil 14. The magnetic pole face 15m of the −X side flat magnet piece 15XM and the winding side face of the focus coil 14 are isolated at an interval along the X axis direction and are arranged opposite to each other.

The +Y side flat magnet piece 15YP is configured on the +Y side of the focus coil 14. The magnetic pole face 15m of the +Y side flat magnet piece 15YP and the winding side face of the focus coil 14 are isolated at an interval along the Y axis direction and are arranged opposite to each other. The −Y side flat magnet piece 15YM is configured on the −Y side of the focus coil 14. The magnetic pole face 15m of the −Y side flat magnet piece 15YM and the winding side face of the focus coil 14 are isolated at an interval along the Y axis direction and are arranged opposite to each other.

The plate springs 17 include a front side plate spring 17A and a back side plate spring 17B. The inner edge of the front side plate spring 17A is connected with the +Z side end face of the lens carrier 13, and the inner edge of the back side plate spring 17B is connected with the −Z side end face of the lens carrier 13. Moreover, the outer edge of the front side plate spring 17A is connected with the +Z side end face of the magnet support 16, and the outer edge of the back side plate spring 17B is connected with the −Z side end face of the magnet support 16. As a result, the plate springs 17 are used for supporting the lens carrier 33 in a suspended mode to be capable of moving in the Z axis direction. Moreover, the front side plate spring 17A is divided into two parts along the X axis direction, and also serves as one part of a power supply path flowing to the focus coil 14.

The base substrate 18 is a quadrangular platelike component with a circular opening part 18a. The printed substrate 22 formed thereon the four correction coils 19 is mounted on the +Z side of the base substrate 18. The printed substrate 22 is a flexible printed substrate, and is also a platelike component with an opening in the central part and extending in a face shape in the direction orthogonal with the Z axis.

The correction coils 19 are printed and formed on the printed substrate 22, and each is in a coil shape by utilizing the method such as copper etching or copper electroplating. Each of the correction coils 19 formed through printing is formed into a spiral coil around a direction parallel with the Z axis direction in a flat shape, and thus the dimensions (height) of the lens driving device 10 in the Z axis direction can become smaller.

As shown in FIG. 1B and FIG. 2A, each correction coil 19 is formed in the shape of a long circle with two long sides (an outer side edge 19o and an inner side edge 19i) and two short curved sides connecting with the two long sides. The correction coils 19 include a +X side coil 19XP, a −X side coil 19XM, a +Y side coil 19YP and a −Y side coil 19YM. The end 22e of the sides of the printed substrate 22 and the end of the sides of the outer side edge 19o of the correction coil 19 are isolated at a certain distance. That is, an upper surface of the printed substrate 22, close to the end 22e, not covered by the outer side edge 19o, can be used as a pattern gap 22k used as the printing allowance for printing the anti-corrosion agent material in the working procedure before the copper etching or the copper electroplating is formed.

As shown in FIG. 2B, the outer side edge 19o of the correction coil 19 is formed closer to the inner side than the outer side corner part (an corner between the outer side face and the −Z side end face) 15o of the magnet 15 in radial direction, and the inner side edge 19i of the correction coil 19 is formed closer to the inner side than the inner side corner part (an corner between the inner side face and the −Z side end face, close to the coil 19 and the focus coil 14) 15i of the magnet 15. For example, the outer side edge 19o of the −X side coil 19XM is configured closer to the +X side than the outer side corner part 15o of the −X side flat magnet piece 15XM, and the inner side edge 19i of the −X side coil 19XM is configured closer to the +X side than the inner side corner part 15i of the −X side flat magnet piece 15XM.

Moreover, as shown in FIG. 2B, the magnets 15 are magnetized slantly. Specifically, the −X side flat magnet piece 15XM is magnetized slantly relative to its magnetic pole face 15m, the magnetic pole face 15m is on the side of the N pole. When observing a cross-sectional view of the magnet 19, wherein the cross section of the magnet 19 is formed by cutting the magnet based on a plane including the normal n (X axis direction) of the magnetic pole face 15m and the optical axis O (Z axis direction), the magnetization direction M is inclined at an angle theta (θ) from the normal n towards a front side of the direction of the optical axis O. Moreover, similar to the −X side flat magnet piece 15XM as shown in FIG. 2B, the unshown +X side flat magnet piece 15XP, +Y side flat magnet piece 15YP and −Y side flat magnet piece 15YM are also inclined at the angle theta towards the front side of the direction of the optical axis O relative to the normal n of the magnetic pole face, and these flat magnet pieces are magnetized in the manner that the magnetic pole face 15m is on the side of the N pole. Namely, the +X side flat magnet piece 15XP is configured on the +X side of the focus coil 14, and the magnetic pole face 15m of the +X side flat magnet piece 15XP and the winding side face of the focus coil 14 are isolated at an interval along the X axis direction and are arranged opposite to each other. The magnetized direction of the +X side flat magnet piece 15XP is inclined at the angle theta towards the front, and is magnetized in the manner that the magnetic pole face 15m of the +X side flat magnet piece 15XP is on the side of the N pole.

Moreover, the +Y side flat magnet piece 15YP is configured on the +Y side of the focus coil 14, and the magnetic pole face 15m of the +Y side flat magnet piece 15YP and the winding side face of the focus coil 14 are isolated at an interval along the Y axis direction and are arranged opposite to each other. The magnetized direction of the +Y side flat magnet piece 15YP is inclined at the angle theta towards the front, and is magnetized in the manner that the magnetic pole face 15m of the +Y side flat magnet piece 15YP is on the side of the N pole.

Moreover, the −Y side flat magnet piece 15YM is configured on the −Y side of the focus coil 14, and the magnetic pole face 15m of the −Y side flat magnet piece 15YM and the winding side face of the focus coil 14 are isolated at an interval along the Y axis direction and are arranged opposite to each other. The magnetized direction of the −Y side flat magnet piece 15YM is inclined at the angle theta towards the front, and is magnetized in the manner that the magnetic pole face 15m of the −Y side flat magnet piece 15YM is on the side of the N pole.

In FIG. 1B, the suspension wires 20 are linear components extending along the Z axis direction, and four suspension wires are configured at four corners respectively one by one. One end of each suspension wire 20 penetrates through the back side plate spring 17B in a non-contact manner so as to be connected with the corner part 22c of the printed substrate 22 and the corner part 18c of the base substrate 18 respectively, and the other ends of the suspension wires 20 are connected with the outer side corner parts 17c of the front side plate spring 17A. As a result, the suspension wires 20 are used for supporting the focus unit 11 to be capable of swinging in the X axis direction and the Y axis direction.

In the focus unit 11 of the lens driving device 10 formed as mentioned above, along with the electrification of the focus coil 14, lorentz force in the Z axis direction is generated by the focus coil 14, so that the lens carrier 13 moves along the Z axis direction until the lorentz force and the restoring force of the plate spring 17 reach a balanced position.

Moreover, in the shaking correction unit 12, along with the electrification of the +X side coil 19XP and the −X side coil 19XM of the correction coils 19, the lorentz force in the X axis direction is generated on the +X side coil 19XP and the −X side coil 19XM, and the focus unit 11 swings in the X axis direction by utilizing the counter-acting force generated by the +X side flat magnet piece 15XP and the −X side flat magnet piece 15XM accordingly. Similarly, along with the electrification of the +Y side coil 19YP and the −Y side coil 19YM of the correction coils 19, the lorentz force in the Y axis direction is generated by the +Y side coil 19XP and the −Y side coil 19YM respectively, and counter-acting force is generated by the +Y side flat magnet piece 15YP and the −Y side flat magnet piece 15YM accordingly, so that the focus unit 11 swings in the Y axis direction.

As mentioned above, the +X side flat magnet piece 15XP, the −X side flat magnet piece 15XM, the +Y side flat magnet piece 15YP and the −Y side flat magnet piece 15YM forming the magnets 15 are magnetized slantly just at the angles theta towards the front. Thus, effective drive force (lorentz force) can be generated by the correction coils 19, wherein the outer side edge 19o is formed closer to the inner side than the outer side corner part 15o of the magnet 15, and the inner side edge 19i is formed closer to the inner side than the inner side corner part 15i of the magnet 15.

For example, FIG. 2C illustrates that the change of the drive force in the X axis direction generated by the outer side edge 19o and the inner side edge 19i of the −X side coil 19XM is illustrated by using a corresponding value (magnetic force ratio) compared with the drive force when the inclination angle theta is 0 degree when the magnetization inclination angle theta of the −X side flat magnet piece 15XM changes. Under the condition that the outer side edge 19o and the inner side edge 19i of the −X side coil 19XM are configured in the positions in FIG. 2B, the most effective thrust force is generated when the magnetization inclination angle theta is set to be about 30 degrees. Right now, in the magnetic figure as shown in FIG. 2D, magnetic induction lines are effectively crossed on the outer side edge 19o and the inner side edge 19i. Thus, by suitably setting the magnetization inclination angle theta according to the position of the correction coils 19, and effective thrust force can be generation, so that the focus unit 11 effectively swings in the X axis direction and the Y axis direction. Thus, the magnetization inclination angle theta is suitably set as long as corresponding to the position of the outer side edge 19o or the inner side edge 19i.

Moreover, even though similar to prior art, the inner side edge 19i of the correction coil 19 is formed right under the −Z side of the inner side corner part 15i of the magnet 15, and only the outer side edge 19o is formed in a staggered manner closer to the inner side than the outer side corner part 15o of the magnet 15, but the effective thrust force can be generated as long as the magnetization inclination angle theta is suitably set.

As shown in FIG. 3, the outer side edges 19o of the correction coils 19 are formed closer to the inner side than the corresponding outer side corner parts 15o of the magnets 15. Thus, even if the end 22e of the printed substrate 22 and the end part of the outer side edge 19o of the correction coil 19 are arranged at a certain distance, the pattern gap 22k as the printing allowance for printing the anti-corrosion agent material before the working procedure of copper etching or copper electroplating is arranged, and the side edge 22e of the printed substrate 22 also impossibly greatly protrudes out of the outer side of the magnets 15. Thus, the end 18e of the base substrate 18 also cannot protrudes out of the outer side of the magnets 15 greatly. Thus, the lens driving device 10 of the present invention can inhibit the end 22e of the printed substrate 22 and the end 18e of the base substrate 18 from protruding, and thus the dimensions in the height direction (Z axis direction) and the radial direction (X axis direction and Y axis direction) can both be miniaturized.

As mentioned above, the small lens driving device 10 with the shaking correction function which is good in driving efficiency can be provided by using the correction coils 19 formed through printing and the magnets 15 magnetized slantly towards the front which are staggered on the inner side in the radial direction of the base substrate 18.

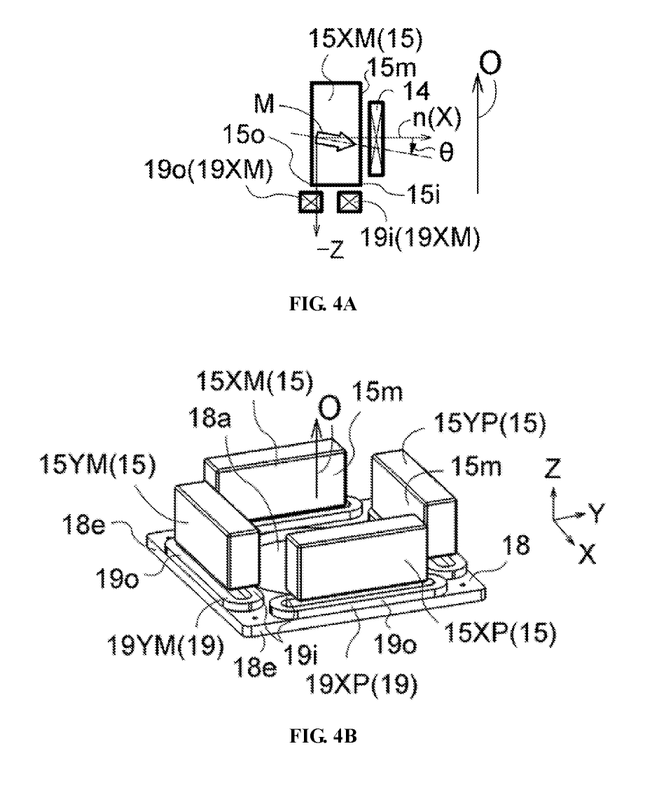

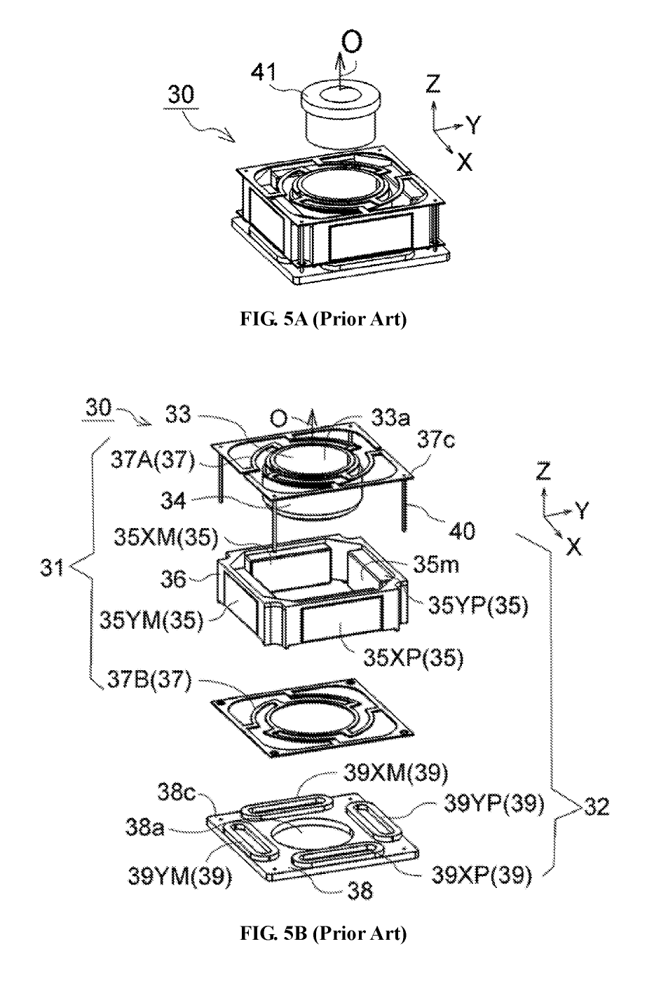

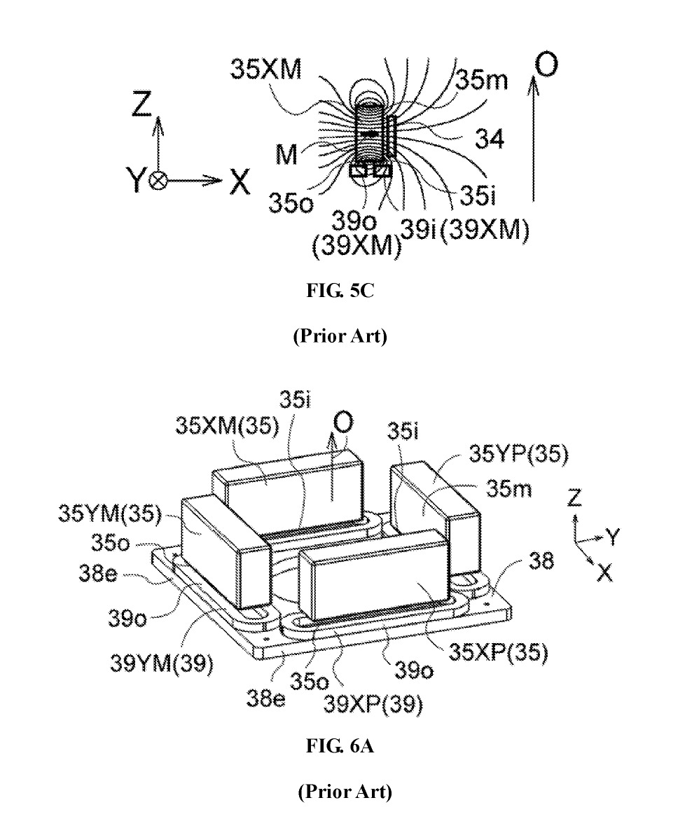

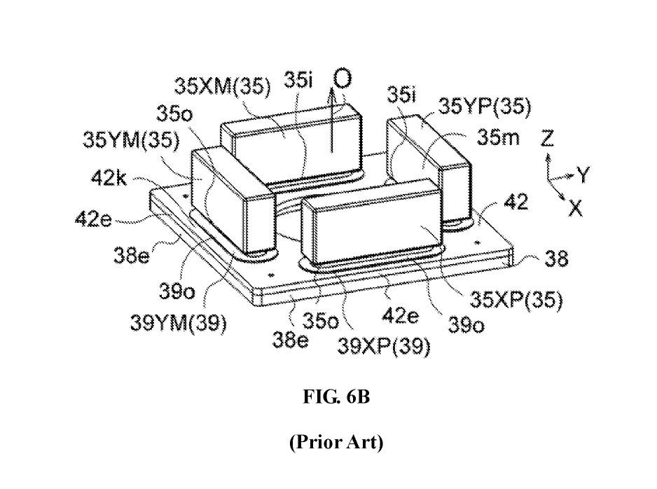

The lens driving device 10 in accordance with a second embodiment is described as follows. FIG. 4A is a mode pattern for illustrating the magnetization direction M of the magnet 15 of the lens driving device 10 in the second embodiment. FIG. 4B is a main partial perspective view of the lens driving device 10 in the second embodiment. Moreover, in the embodiment, the graphical representation of the same component as those in the first embodiment is omitted, and only different parts are illustrated.

The differences between the lens driving devices 10 in the second embodiment and in the first embodiment include: the magnetization direction M of the magnet 15 is different, and the correction coils 19 are copper winding components, but not be printed and formed on the printed substrate 22. The other structures of the lens driving device 10 of the second embodiment are the same as those of the first embodiment. Moreover, in the following specification, the unshown components are also illustrated by using the same figure marks.

The lens driving device 10 in the second embodiment includes the focus unit 11 for enabling the lens 21 to move along the Z axis direction and the shaking correction unit 12 for enabling the lens 21 to swing in directions forming the right angle with the Z axis.

The focus unit 11 includes a lens carrier 13, a focus coil 14, magnets 15, a magnet support 16 and plate springs 17. Moreover, the shaking correction unit 12 includes a base substrate 18, correction coils 19 formed by winding copper component, the magnets 15 shared with the focus unit 11, and the suspension wires 20.

The base substrate 18 is a quadrangular platelike component with a circular opening part 18a. The correction coil 19 is mounted on the +Z side of the base substrate 18.

As shown in FIG. 4B, each correction coil 19 is a component formed by winding a copper wire. The correction coil 19 is positioned at the position closer to the outer side than the opening part 18a of the base substrate 18 in radial direction, and is mounted on the +Z side face of the base substrate 18. More specifically, the +X side coil 19XP is wound around the axis parallel to the Z axis in the shape of the long circle, is mounted on the +Z side face of the base substrate 18, and is isolated from the side face on the −Z side of the +X side flat magnet piece 15)CM at an interval along the Z axis direction and is arranged opposite to the −Z side face of the +X side flat magnet piece 15)CM. Moreover, the −X side coil 19XM is wound around the axis parallel to the Z axis in the shape of the long circle, is mounted on the +Z side face of the base substrate 18, and is isolated from the side face on the −Z side of the −X side flat magnet piece 15XM at an interval along the Z axis direction and is arranged opposite to the −Z side face of the −X side flat magnet piece 15XM.

Moreover, the +Y side coil 19YP is wound around the axis parallel to the Z axis in the shape of the long circle, is mounted on the +Z side face of the base substrate 18, and is isolated from the side face on the −Z side of the +Y side flat magnet piece 15YP at an interval along the Z axis direction and is arranged opposite to the side face on the −Z side of the +Y side flat magnet piece 15YP. Moreover, the −Y side coil 19YM is wound around the axis parallel to the Z axis in the shape of the long circle, is mounted on the +Z side face of the base substrate 18, and is isolated from the side face on the −Z side of the −Y side flat magnet piece 15YM at an interval along the Z axis direction and is arranged opposite to the side face on the −Z side of the −Y side flat magnet piece 15YM.

As shown in FIG. 4A, the outer side edge 19o of the correction coil 19 is arranged under the −Z side of the outer side corner part 15o of the magnet 15, and the inner side edge 19i of the correction coil 19 is arranged closer to the outer edge of the base substrate 18 than the inner side corner part 15i of the magnet 15. For example, similar to the illustrated −X side flat magnet piece 15XM and −X side coil 19XM, the inner side edge 19i of the −X side coil 19XM is arranged closer to the −X side than the inner side corner part 15i of the −X side flat magnet piece 15XM, while the outer side edge 19o of the −X side coil 19XM is arranged right under the outer side corner part 15o of the −X side flat magnet piece 15XM in the −Z side. Thus, the inner side edge 19i of the correction coil 19 is offset to the outside in the radial direction of the base substrate 18, and thus the opening part 18a of the base substrate 18 can become wider.

As shown in FIG. 4A, the magnet 15 is magnetized slantly. The −X side flat magnet piece 15XM is magnetized slantly relative to its magnetic pole face 15m. When observed from the Y axis direction, the magnetization direction M is inclined at the angle theta from the normal n towards the back side (-Z side) of the direction of the optical axis O, and the magnetic pole face 15m is on the side of the N pole. Moreover, similar to the −X side flat magnet piece 15XM, the unshown +X side flat magnet piece 15XP, +Y side flat magnet piece 15YP and −Y side flat magnet piece 15YM are also inclined at the angle theta towards the back side of the optical axis O, and these flat magnet pieces are magnetized in the manner that the magnetic pole face 15m is on the side of the N pole.

Namely, the +X side flat magnet piece 15XP is configured on the +X side of the focus coil 14, and the magnetic pole face 15m of the +X side flat magnet piece 15XP and the winding side face of the focus coil 14 are isolated at an interval along the X axis direction and are arranged opposite to each other. The magnetization direction M of the +X side flat magnet piece 15XP is inclined at the angle theta towards the back side, and is magnetized in the manner that the magnetic pole face 15m of the +X side flat magnet piece 15XP is on the side of the N pole.

Moreover, the +Y side flat magnet piece 15YP is configured on the +Y side of the focus coil 14, and the magnetic pole face 15m of the +Y side flat magnet piece 15YP and the winding side face of the focus coil 14 are isolated at an interval along the Y axis direction and are arranged opposite to each other. The magnetization direction M of the +Y side flat magnet piece 15YP is inclined at the angle theta towards the back side, and is magnetized in the manner that the magnetic pole face 15m is on the side of the N pole.

Moreover, the −Y side flat magnet piece 15YM is configured on the −Y side of the focus coil 14, and the magnetic pole face 15m of the −Y side flat magnet piece 15YM and the winding side face of the focus coil 14 are isolated at an interval along the Y axis direction and are arranged opposite to each other. The magnetization direction M of the −Y side flat magnet piece 15YM is inclined at the angle theta towards the back side, and is magnetized in the manner that the magnetic pole face 15m is on the side of the N pole.

The +X side flat magnet piece 15XP, the −X side flat magnet piece 15XM, the +Y side flat magnet piece 15YP and the −Y side flat magnet piece 15YM are all magnetized slantly just the angles theta towards the back side. Thus, the effective drive force (lorentz force) can be generated by the correction coils 19 whose inner side edges 19i are formed to be closer to the outer side than the inner side corner parts 15i of the magnets 15.

Thus, in the lens driving device 10 of the second embodiment, the magnets 15 are magnetized slantly towards the back side in the direction of the optical axis, and thus the inner side edge 19i of the correction coils 19 can be configured towards the outer side in the radial direction of the base substrate 18. Thus, in the lens driving device 10 of the second embodiment, the opening part 18a of the base substrate 18 can become larger, accordingly the lens driving device 10 with the shaking correction function which can prevent the opening part 18a of the base substrate 18 from generating dark aperture and is high in driving efficiency can be provided.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A lens driving device with a shaking correction function, comprising:
an auto focus unit configured for driving a lens to move along an optical axis of the lens, an object to be shot being at a front side of the optical axis; and
a shaking correction unit configured for driving the auto focus unit to swing in directions forming a right angle with the optical axis;
wherein the auto focus unit comprises:
a focus coil configured on the outside of the lens and wound around the optical axis; and
a plurality of magnets configured on the outside of the focus coil;
wherein a magnetic pole face of each of the plurality of magnets is isolated from the focus coil at an interval along a radial direction of the lens and is arranged opposite to the focus coil;
wherein the shaking correction unit comprises a plurality of correction coils wound around axises parallel with the optical axis;
wherein each correction coil is isolated from a corresponding one of the plurality of magnets at an interval along the direction of the optical axis and is arranged opposite to the corresponding one of the plurality of magnets;
wherein each magnet is magnetized along a first direction which is rotated around a second direction from the a normal of the magnetic pole face of the magnet for an angle, the second direction is perpendicular to the optical axis and the normal of the magnetic pole face of the magnet.

2. The lens driving device of claim 1, wherein the magnetization direction of the magnet is inclined towards the front side of the direction of the optical axis relative to the normal of the magnetic pole face when the cross section of the magnet is observed from the plane including the optical axis and the normal of the magnetic pole face.

3. The lens driving device of claim 1, wherein that the magnetization direction of the magnet is inclined towards the back side of the direction of the optical axis relative to the normal of the magnetic pole face when the cross section of the magnet is observed from the plane including the optical axis and the normal of the magnetic pole face.

4. A lens driving device with a shaking correction function, comprising:
an auto focus unit configured for driving a lens to move along an optical axis of the lens, an object to be shot being at a front side of the optical axis; and
a shaking correction unit configured for driving the auto focus unit to swing in directions forming a right angle with the optical axis;
wherein the auto focus unit comprises:
a focus coil configured on the outside of the lens and wound around the optical axis; and
a plurality of magnets configured on the outside of the focus coil;
wherein a magnetic pole face of each of the plurality of magnets is isolated from the focus coil at an interval along a radial direction of the lens and is arranged opposite to the focus coil;
wherein the shaking correction unit comprises a plurality of correction coils wound around axises parallel with the optical axis;
wherein each correction coil is isolated from a corresponding one of the plurality of magnets at an interval along the direction of the optical axis and is arranged opposite to the corresponding one of the plurality of magnets;
wherein a magnetization direction of each of the plurality of magnets is not perpendicular to the optical axis when observing a cross section of the magnet, the cross section is formed by cutting the magnet along a plane including the optical axis and the normal of the magnetic pole face of the magnet.

5. The lens driving device of claim 4, wherein a magnetization direction of each of the plurality of magnets is inclined from the normal of the magnetic pole face of the magnet towards a front side or a back side of the direction of the optical axis when observing the cross section of the magnet.

6. The lens driving device of claim 5, wherein a magnetization inclination angle between the magnetization direction and the normal of the magnetic pole face of the magnet is 10˜55 degrees.

7. A lens driving device with a shaking correction function, comprising:
an auto focus unit configured for driving a lens to move along an optical axis of the lens, an object to be shot being at a front side of the optical axis; and
a shaking correction unit configured for driving the auto focus unit to swing in directions forming a right angle with the optical axis;
wherein the auto focus unit comprises:
a focus coil configured on the outside of the lens and wound around the optical axis; and
a plurality of magnets configured on the outside of the focus coil;
wherein a magnetic pole face of each of the plurality of magnets is isolated from the focus coil at an interval along a radial direction of the lens and is arranged opposite to the focus coil;
wherein the shaking correction unit comprises a plurality of correction coils wound around axises parallel with the optical axis;
wherein each correction coil is isolated from a corresponding one of the plurality of magnets at an interval along the direction of the optical axis and is arranged opposite to the corresponding one of the plurality of magnets;
wherein a magnetization direction of each of the plurality of magnets is inclined relative to a normal of the magnetic pole face of the magnet, and the normal of the magnetic pole face of the magnet is perpendicular to the optical axis.

8. The lens driving device of claim 7, wherein a magnetization direction of each of the plurality of magnets is inclined from the normal of the magnetic pole face of the magnet towards a front side or a back side of the direction of the optical axis when observing a cross section of the magnet, the cross section is formed by cutting the magnet along a plane including the optical axis and the normal of the magnetic pole face of the magnet.

9. The lens driving device of claim 8, wherein a magnetization inclination angle between the magnetization direction and the normal of the magnetic pole face of the magnet is 10˜55 degrees.
